(19) United States
(12) Patent Application Publication
(10) Pub. No.: US 2004/0133741 A1
(43) Pub. Date: Jul. 8, 2004

(54) Disk array apparatus and data writing method used in the disk array apparatus

(75) Inventor: Atsushi Kuwata, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/720,162

(22) Filed: Nov. 25, 2003

(30) Foreign Application Priority Data
Jan. 7, 2003 (JP) 2003-001314

(51) Int. Cl. G06F 12/08

(52) U.S. Cl. 711/113; 711/203; 714/5; 711/114

(57) ABSTRACT

A disk array apparatus includes a cache memory for temporarily storing data to be read from or written to disks, and a control unit. The control unit associates data associated with logical addresses with physical addresses, writes the data associated with physical address in the cache memory and processes preferentially for writing the data associated with the physical addresses in the cache memory to the disks.

### BACKGROUND OF THE INVENTION

The present invention relates to a disk array apparatus, and more particularly to a disk array apparatus for reading and writing data from and to a plurality of disks in accordance with a command issued from an upper-level host computer.

In a disk array apparatus, a plurality of disks is grouped and data to be stored is given redundancy, so that even if a single disk failure occurs, no data is lost, and hence a data processing can be continuously executed. The disk array apparatus is called RAID (Redundant Arrays of Inexpensive Disk). There are different techniques for giving data redundancy, and these methods are called a RAID level. Since Level 5 RAID is superior to others in capacity efficiency, the Level 5 RAID is especially useful and has come into wide use. The RAID level is explained in detail in a paper entitled “A Case for Redundant Arrays of Inexpensive Disks” by Professors David A. Patterson, Garth Gibson, and Randy Katz, California University at Berkeley, 1987. Here, the Level 5 RAID distributes data and check information per sector across all disks including a check disk. In addition, an example of a disk array apparatus made for practical use is disclosed in Japanese Patent laid-Open No 2001-344076.

A write processing in the Level 5 RAID will now be described with reference to FIGS. 8(a), (b), and (c). Disks 101 to 105 constitute the Level 5 RAID, and areas 111 to 115 are formed in which data is to be stored. Then, user data is stored in the areas 111 to 114, and also check information of the areas 111 to 114 is stored in the area 115.

A description will now be given with respect to a case where data 121 is written to the area 111. When the data 121 is intended to be written, not only the contents of the area 111 must be updated for new data, but also the contents of the area 115 must be updated for check information corresponding to the new data. Thus, first of all, as shown in FIG. 8(a), prior to a write operation, old data 122, and old check information 123 are read out from the area 111 and the area 115, respectively. Next, as shown in FIG. 8(b), new check information 124 is generated from the three data sets consisting of the write data 121, the old data 122, and the old check information 123. Finally, as shown in FIG. 8(c), the write data 121 and the new check information 124 are written to the disks 101 and 105, respectively. It is assumed that when the write data and the check information are written to the data disk 101 for storing the write data and the check information disk 105 for storing the check information, respectively, the data can be written to any one of the data disk 101 and the check information disk 105; however, if either type of data cannot be written to its intended location, then the processes of FIGS. 8(a) to (c) are simply re-executed from the beginning. This creates the problem that the check information takes on an improper value. If the check information has an improper value, when one of the disks is damaged, recovery of the data is executed with the improper check information. That is, the recovered data is in error. As a result, there occurs a problem in that reliability of reading and writing of data is reduced.

### SUMMARY OF THE INVENTION

It is an object of the present invention to provide a disk array apparatus which maintains data coherency in a case wherein, when the write data and check information are being written to a data disk for storing the write data and a check information disk for storing the check information, respectively, one of the data and the check information can be written, but the other cannot be written.

According to the invention, before executing a processing for writing data to the disks, a control unit associates the data intended to be written to the disks with physical addresses to store the data in cache memory. As a result, the data intended to be written to the respective disks, before being written, is associated with physical addresses to be stored in the cache memory. After write processing the data to the disks and confirming that the writing is completed, the control unit releases the write data associated with the physical addresses on the cache memory from a state in which the write data is associated with the physical addresses, respectively. Hence, the write data associated with the physical address on the cache memory is allowed to remain in the cache memory as long as the processing for writing data is not perfectly completed. Thereafter, the write processing of the data associated with the physical address on the cache memory is preferentially executed. Therefore, the same write processing as that before occurrence of a failure can be continuously executed to allow data coherency to be maintained.

In addition, it is desirable to include a plurality of control units which are physically independent of one another. As a result, even if a failure occurs in one control unit, another control unit takes over the preference processing for the data associated with a physical address in the cache memory to thereby allow data coherency to be maintained.

Further, if the cache memory is a nonvolatile memory, then even when the operation of the disk array apparatus itself is stopped due to a failure, the data associated with a physical address remains in the cache memory. Hence, the processing is continuously executed for such data to thereby allow data coherency to be maintained.

Other and further objects of this invention will be more apparent upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

For a better understanding of the invention of the invention as well as other objects and features thereof, reference is made to the following detailed description to be read in conjunction with the accompanying drawings, wherein:

FIG. 1 is a block diagram outlining a data processing according to an embodiment of the present invention;

FIG. 2 is a block diagram showing a configuration according to the embodiment of the present invention;

FIG. 3 is a block diagram showing a data structure in a cache memory;

FIG. 4 is a flowchart showing an operation for a read processing executed by an embodiment of the present invention;

FIG. 5 is a flowchart showing an operation for a write processing executed by an embodiment of the present invention;

FIG. 6 is a flowchart showing an operation for a processing for writing data stored in a cache memory through the write processing shown in FIG. 5 to respective disks;

FIG. 7 is a flowchart showing an operation for a processing for writing data remaining in a physical domain of a cache memory in the write processing shown in FIG. 6 to respective disks;

FIG. 8(a) is a diagram for explaining a first processing for writing data in a conventional disk array apparatus;

FIG. 8(b) is a diagram for explaining a second processing for writing data in a conventional disk array apparatus; and

FIG. 8(c) is a diagram for explaining a third processing for writing data in a conventional disk array apparatus.

### DETAILED DESCRIPTION OF THE PREFERRED EMBODIMENTS

A disk array apparatus according to an embodiment of the present invention reads out and writes data from and to a plurality of disks in accordance with an instruction issued from an upper-level host computer such as a personal computer or a server computer by utilizing a Level 5 RAID. At this time, in the disk array apparatus, a processing for reading out or writing data is controlled by a director as a control unit, and data intended to be read out or written from or to respective disks is temporarily stored in a cache memory. Then, on the cache memory, the director associates data associated with a logical address used in the upper-level host computer with a physical address. In this state, the director controls the processing for reading out or writing data from or to the respective disks with the cache memory.

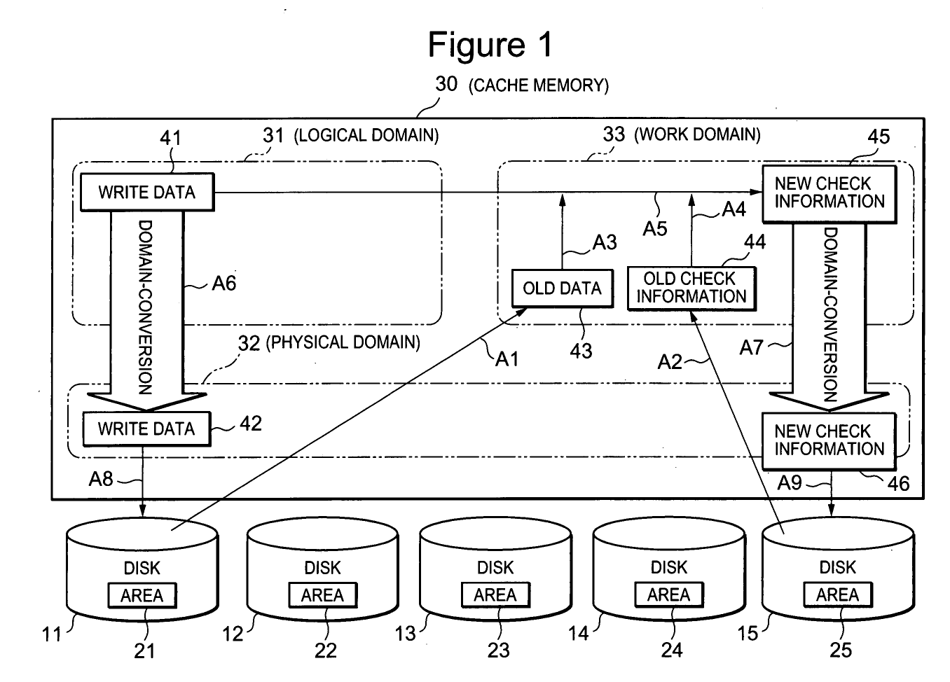

In FIG. 1, disks 11 to 15 constitute the Level 5 RAID. A cache page is an area adapted to store data (an area in which write data, new check information, and the like for example are stored) present on a cache memory 30 in which data intended to be read out or written from or to respective disks is temporarily stored. Then, the cache page belongs to any one of areas named a logical domain 31, a physical domain 32, and a work domain 33. Here, by the logical domain 31 is meant a place to which data associated with a logical address belongs, and by the physical domain is meant a place to which data associated with a physical address 32 belongs. In addition, by the work domain is meant a place to which data not associated with either a logical address or a physical address belongs. In practice, unlike FIG. 1, areas are not physically assigned to the respective domains. These domains are shown as in FIG. 1 for ease of description and understanding.

Assume that write data 41 received from an upper-level host computer (not shown) is present on the cache memory 30. Since this data is stored in a cache page which can be retrieved with a logical address, this data belongs to the logical domain 31. In FIG. 1, a disk to which this data is intended to be written is a disk 11, and corresponding check information is present in a disk 15. Hence, old data 43 and old check information 44 are previously read out from addresses corresponding to the above-mentioned logical address (refer to arrows A1 and A2). More specifically, the old data 43 is data stored in an area 21 on the disk 11 corresponding to the logical address associated with the write data 41. Likewise, the old check information 44 is data stored in an area 25 of the disk 15. Hence, the old data 43 and the old check information 44 are read out from the areas 21 and 25 of the disks 11 and 15, respectively. By the way, areas 22 to 24 corresponding to other data are formed in other disks 12 to 14, respectively.

New check information 45 is generated in the work domain 33 on the basis of the write data 41 in the logical domain 31, and the old data 43 and the old check information 44 in the work domain 33 (refer to arrows A3, A4, and A5). The reason why the old data 43, the old check information 44, and the new check information 45 belong to a cache page of the work domain 45 is that the old data 43, the old check information 44, and the new check information 45 are data which are temporarily stored in order to execute reading or writing processing for such data.

Next, the write data 41 and the new check information 45 are domain-converted into data on a cache page in the physical domain 32. That is, since the write data 41 has been sent to the disk array apparatus in accordance with the instruction issued from the upper-level host computer (not shown), the write data 41 is managed in the logical domain 31 in a state in which the write data 41 is associated with the logical address. Thus, the write data 41 is domain-converted so as to be associated with the physical address (refer to arrows A6 and A7).

Next, there is executed a processing for writing the write data 41 and the new check information 45 to the disks 11 and 15, respectively (refer to arrows A8, A9). Concerning the processing for writing, the cache pages in the physical domain are given priority. As a result, even if a director failure occurs during the execution of the processing for writing to the respective disks, the write data and the new check information to be written to the disk 11 and 15 remain in the cache pages of the physical domain 32. Hence, the write data and the new check information are written to the respective disks again to thereby allow data coherency to be maintained.

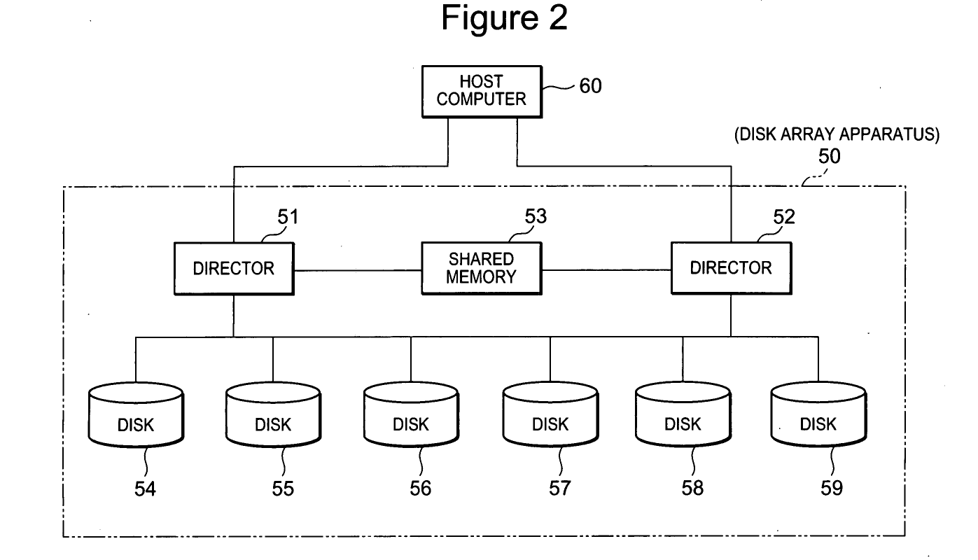

A specific example of the present invention will now be described with reference to FIGS. 2 to 7. First of all, as shown in FIG. 2, a disk array apparatus 50 of the present invention includes two directors 51 and 52 each serving as a control unit for controlling a processing for reading out or writing data. The directors 51 and 52 are connected to a host computer 60 through a general purpose interface such as an SCSI and serve to process commands issued from the host computer 60, respectively. In addition, the directors 51 and 52 are also connected to disks 54 to 59 through a general purpose interface and serve to store data transferred from the host computer 60 in suitable places of the disks, and to read out necessary data from the disks. Whereas in this embodiment two directors 51 and 52 are provided, the present invention is not necessarily limited to this case. That is, the number of directors may be one, or three or more. In addition, the directors 51 and 52 are formed physically independent of each other. That is to say, the disk array apparatus is not configured such that two functions are present within one CPU, but in the example shown in FIG. 2, the two directors 51 and 52 are configured in the form of two separate hardware items.

Moreover, the directors 51 and 52 are connected to a shared memory 53 as one and the same storage means. The shared memory 53 is used as a cache memory, and also is a non-volatile memory. Each of the directors 51 and 52 temporarily stores data to be sent to or received from the host computer 60 in the shared memory 53, thereby making it possible to respond to a command issued from the host computer 60 at a high speed. Note that the shared memory 53 may not be composed of a non-volatile memory.

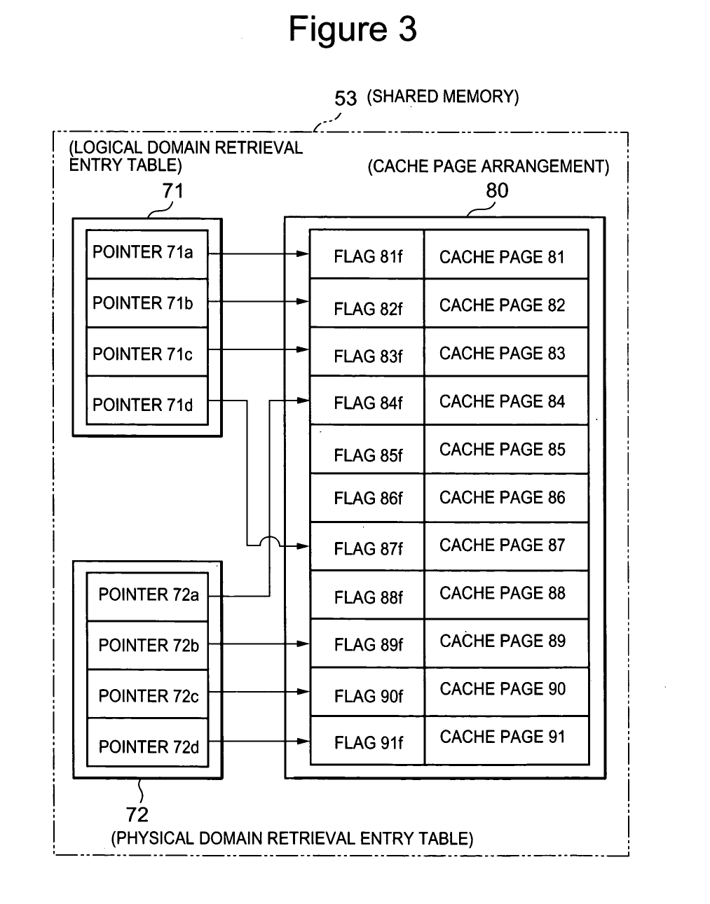

Referring to FIG. 3, a description will now be given with respect to a data structure in the shared memory 53 functioning as the above-mentioned cache memory. A logical domain retrieval entry table 71, a physical domain retrieval entry table 72, and a cache page arrangement 80 are present on the shared memory 53. In the cache page arrangement 80, there are a plurality of cache pages 81 to 91. The logical domain retrieval entry table 71 has pointers 71a to 71d corresponding to the one of which is uniquely determined on the basis of a logical address. The pointers indicate the cache pages which is associated with the logical address. Therefore, by referring to the logical domain retrieval entry table 71, a corresponding one of the cache pages belonging to the logical domain 31 can be retrieved from any one of the pointers 71a to 71d. Likewise, by referring to the physical domain retrieval entry table 72, a corresponding one of the cache pages which is associated with a physical address can be retrieved from any one of pointers 72a to 72d which is uniquely determined on the basis of the physical address. The retrieved cache page is a cache page belonging to the physical domain 32.

In addition, in the cache page arrangement 80, there are flags 81f to 91f corresponding to the cache pages 81 to 91, respectively. The function of the flags will be described later. Data (write data, check information, or the like) which is intended to be read from or written to the respective disks are stored in the cache pages. In addition, all the cache pages 81 to 91 belong to any of the above-mentioned logical domain 31, physical domain 32, and work domain 33, respectively.

As indicated by arrows of FIG. 3, the cache pages 81, 82, 83, and 87 can be retrieved from the logical domain retrieval entry table 71. Accordingly, these cache pages belong to the logical domain 31. In addition, the cache pages 84 and 91 can be retrieved from the physical domain retrieval entry table 72. Accordingly, these cache pages belong to the physical domain 32. The remaining cache pages, i.e., the cache pages 85, 86, 88, 89, 90, and 91 which are not associated with the physical address or the logical address are cache pages belonging to the work domain 33.

In addition, each of the directors 51 and 52 shown in FIG. 2 has functions which will be described below. Each of the directors 51 and 52 has a function of, before a processing for writing data to the respective disks, storing the data intended to be written to the respective disks in the shared memory (cache memory) in a state in which the data is associated with physical addresses. Accordingly, the data which is an object of a write processing is usually stored in the physical domain 32 before the processing for writing the data is executed. Also, each of the directors 51 and 52 has a function of, after a processing for writing data to the respective disks is executed, confirming that the write processing is completed. Each of the directors 51 and 52, after confirming the completion of the write processing, releases the write data from a state in which the write data is associated with physical addresses on the cache memory. That is to say, the write data is moved or deleted from the physical domain 32. Consequently, the data as an object of a write processing is left to remain in the physical domain 32 as long as the data as an object of a write processing is not perfectly written to the respective disks. Thereafter, the data within the physical domain 32 is processed by the directors 51 and 52 so as to take precedence over the data on the disks corresponding to the physical addresses. Namely, when there is data belonging to the physical domain 32, the processing for the data is executed so as to take precedence over a processing for reading out other data from the respective disks, a processing for writing other data to the respective disks, and the like.

In addition, each of the directors 51 and 52 has a function of, even when a failure occurs in any one of the disks, executing a processing for reading out or writing data from or to the respective disks without disabling the faulty disk. That is to say, even when a minor failure merely occurs, a processing for reading out or writing data from or to the respective disks is not stopped, but is continuously executed.

In this embodiment, two directors 51 and 52 are provided. With a configuration having a plurality of directors in such a manner, each director monitors situations of other directors, and if a failure occurs in any one of the other directors, then a processing to be executed by the faulty director is taken over to execute a processing for reading out or writing data from or to the respective disks. For example, if a failure occurs in one director 51 when data stored in the physical domain 32 in the shared memory 53 is intended to be written to the respective disks, then the other director 52 preferentially processes the data stored in the physical domain 32 to continuously execute a processing for writing the data to the respective disks similarly to the processing state before a failure occurs.

The present invention is not necessarily limited to a case where each of the directors 51 and 52 has all the above-mentioned functions. Thus, the present invention may also be applied to a case where each of the directors 51 and 52 does not have some of these functions. In addition, a program for these functions is previously incorporated in each of the directors 51 and 52, or is previously stored in a storage unit such as a non-volatile memory. The program for these functions is read out thereby to install these functions in each of the directors 51 and 52. As a result, the above-mentioned functions can be realized. The above-mentioned functions will be described in greater detail in the following description of an operation.

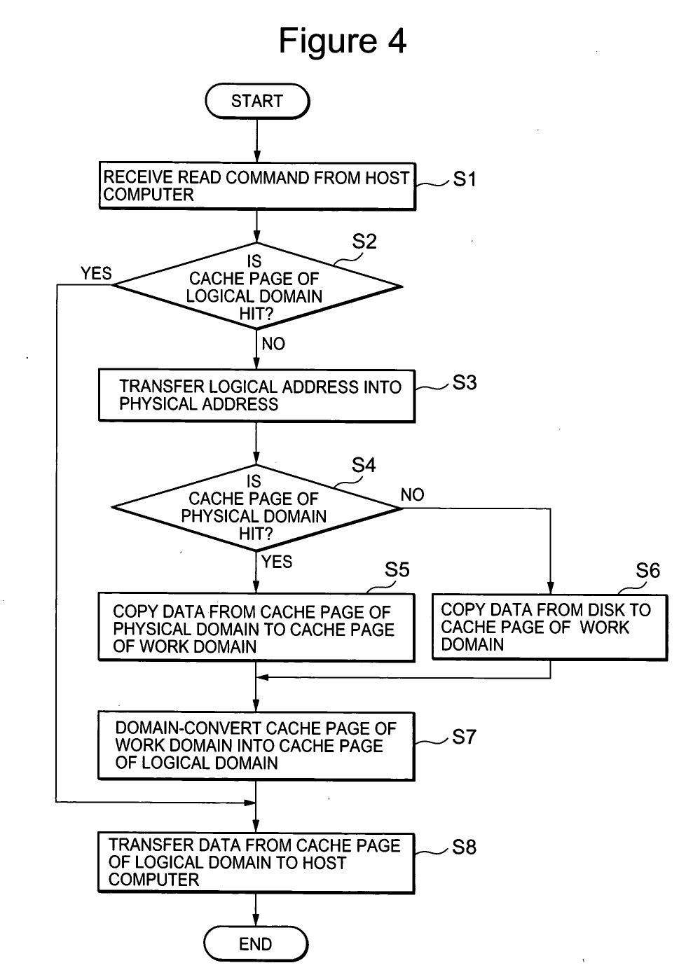

The operation of the disk array apparatus 50 in this embodiment will now be described with reference to the flowcharts of FIGS. 4 to 7.

The read processing of FIG. 4 will now be described. First, at the time when each of the directors 51 and 52 of the disk array apparatus 50 has received from the host computer 60 a read command issued to read out predetermined data on the disks (Step S1), it is checked using the logical domain retrieval entry table 71 in the shared memory 53 whether or not data is present in a logical address as a read object, i.e., there is a logical domain cache page as a read object (Step S2). Judging whether or not there is a cache page will be referred to herein as a “hit judgment”, and it is referred to as a “hit” when there is a cache page as a read object.

If it is judged that a cache page is hit, i.e., there is a cache page as a read object, which corresponds to a judgment of “YES” in Step S2, data is transferred from the cache page to the host computer 60 (Step S8). On the other hand, if it is judged that a cache page is not hit, then a corresponding physical address is calculated from a logical address to be address-transferred (Step S3). Then, it is judged using the physical domain retrieval entry table 72 whether or not there is data in the physical address obtained through the address transformation, i.e., the hit judgement is performed concerning the physical domain cache page (Step S4).

Here, if it is judged that the physical domain cache page is hit, that is, a judgment is “YES” in Step S4, then data is copied from the physical domain cache page to a cache page of the work domain 33 (Step S5). On the other hand, if it is judged that no cache page is hit, that is, judgment is “NO” in Step S4, then data is copied from the disk to the cache page of the work domain 33 (Step S6). Then, since in any case the necessary data is stored in the cache page of the work domain 33, the cache page of the work domain 33 in which the data is stored is domain-transformed into the cache page of the logical domain 31 (Step S7). More specifically, this processing is executed by rewriting the pointers so that the pointers of the logical domain retrieval entry table 71 are made to refer to the cache page of the work domain 33. As a result, the cache page of the work domain can be retrieved on the basis of the logical address. Thereafter, data as the read object is transferred from the logical domain cache page to the host computer 60 (Step S8). By executing the above processing, the read command processing is completed.

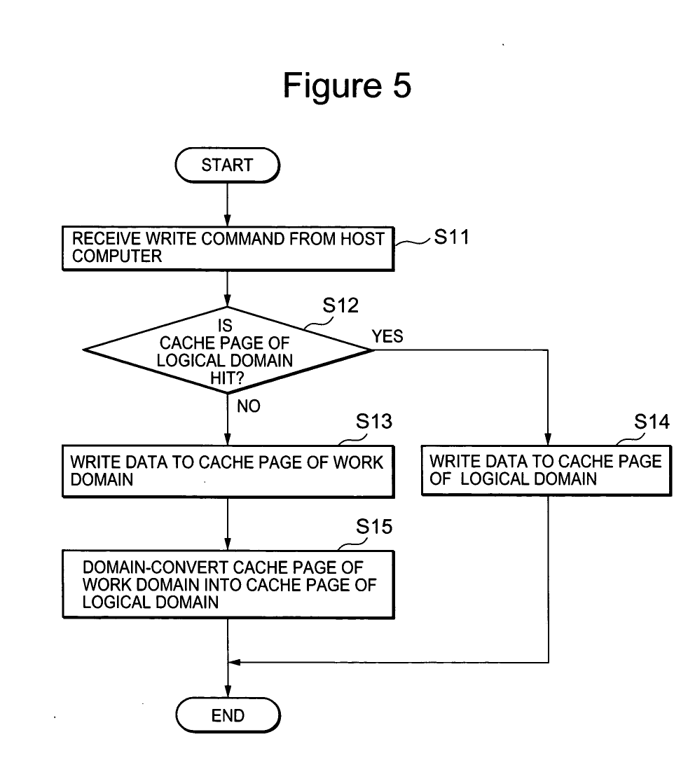

The write operation shown in FIG. 5 will now be described. First of all, at the time when each of the directors 51 and 52 has received from the host computer 60 a write command to record data in the respective disks (Step S11), it is judged using the logical domain retrieval entry table 71 whether or not there is a logical domain cache page corresponding to the logical address (Step S12). If it is judged that the cache page is hit, that is, a judgment is “YES” in Step S12, then write data is transferred from the host computer 60 to the cache page (Step S14). At this time, a flag accompanying the cache page is set.

On the other hand, if it is judged in Step S12 that no cache page is hit, that is, a judgment is “NO”, write data is transferred from the host computer 60 to the cache page of the work domain 33 (Step S13). Then, the cache page of the work domain 33 in which the data is stored is domain-transferred to a cache page of the logical domain 31 (Step S15). By executing the above processing, the write command processing is completed.

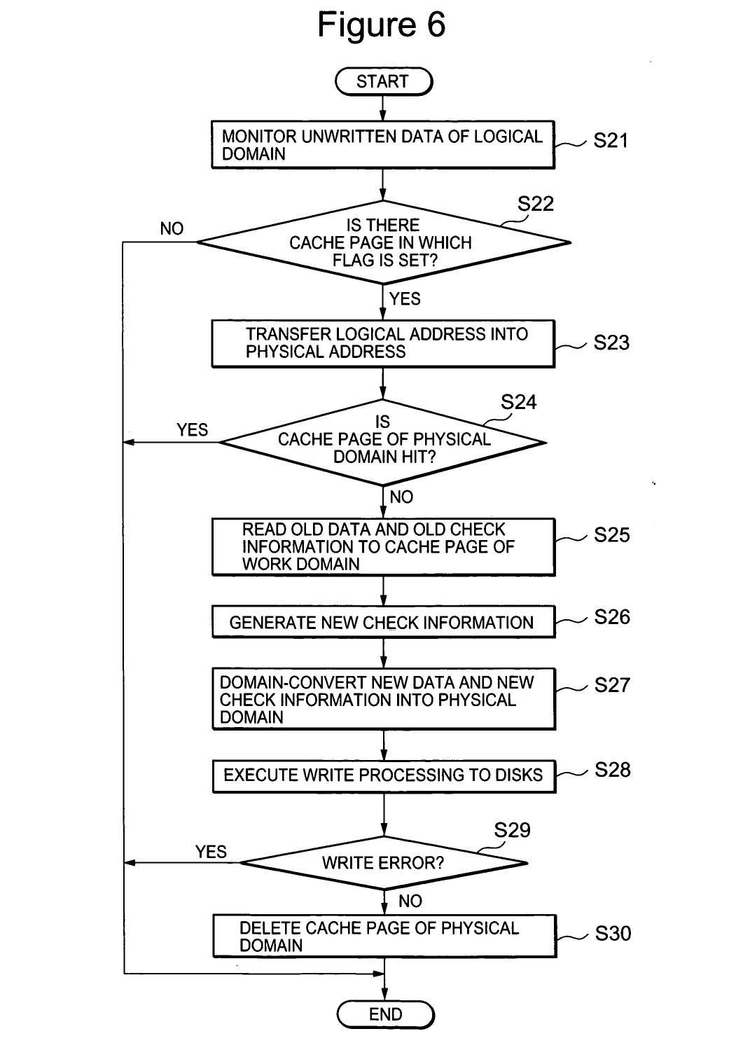

A processing for writing data stored in the cache memory to the respective disks will now be described with reference to a flowchart of FIG. 6. Here, in each of the directors 51 and 52, a processing for monitoring unwritten data in the logical domain 31 is periodically executed asynchronously with the operation for the above-mentioned command processing (Step S21). More specifically, the monitoring processing is executed by retrieving the cache page in which the flag accompanying the logical domain 31 is set (Step S22).

If it is judged that the cache page in which the flag is set is present, i.e., a judgment is “YES” in Step S22, then a corresponding physical address is calculated from a logical address of the cache page, i.e., the logical address is address-transformed into the physical address (Step S23). Then, it is judged using the physical domain retrieval entry table 72 whether or not the cache page of the physical domain 32 is hit (Step S24).

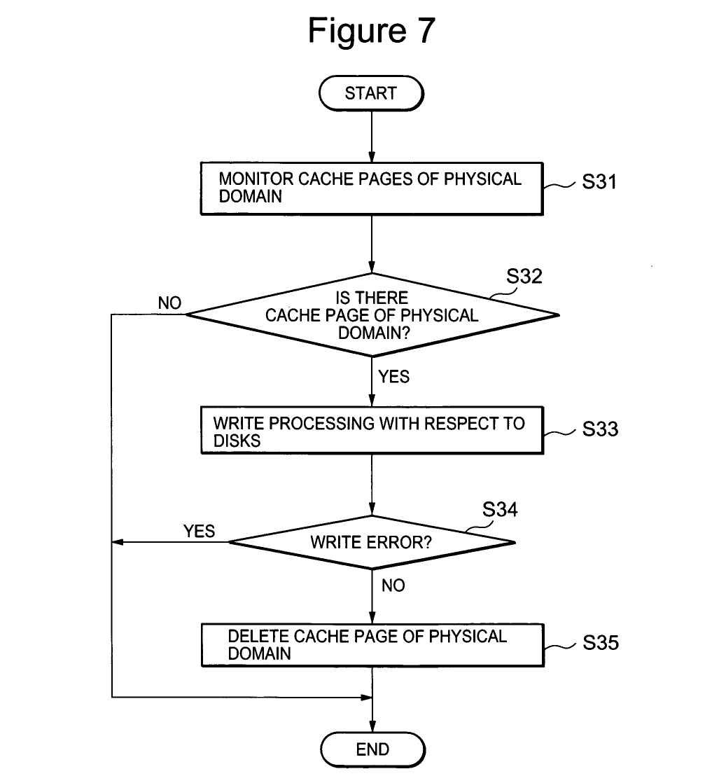

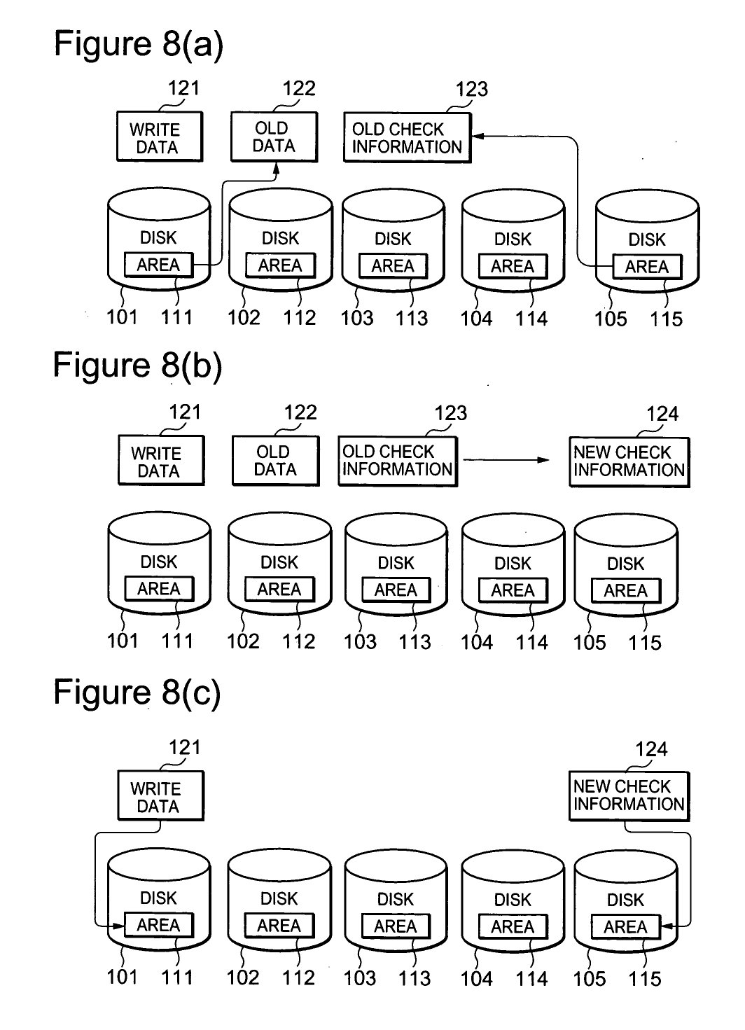

If it is judged that the cache page of the physical domain 32 is hit, that is, a judgment is “YES” in Step S24, then since write data is already associated with the physical address, the processing for writing data to the cache page is not executed at this time, but the data will be written in a later processing (refer to FIG. 7). On the other hand, if it is judged that no cache page of the physical domain is hit, that is, judgment is “NO” in Step S24, then old data and old check information are read out from the corresponding disk to a cache page of the work domain 33 (Step S25, refer to reference numerals 43 and 44 of FIG. 1). Then, a new check information is generated in a cache page of the work domain 33 using the old data, the old check information, and write data (Step S26, refer to reference numeral 45 of FIG. 1).

Subsequently, the write data and the new check information are domain-transformed into the physical domain 32 (Step S27). More specifically, this processing is executed such that the pointers of the logical domain retrieval entry table 71 and the pointers of the physical domain retrieval entry table 72 are rewritten to thereby allow the write data and the new check information to be retrieved on the basis of the physical address. At the same time, the flag accompanying the cache page is reset.

Thereafter, data is transferred from the cache page after the domain transformation to the corresponding disk to actually execute a write processing (Step S28). Then, it is judged whether or not a write error occurs (error judgement, in Step S29). If it is judged that no error occurs, that is, a judgment is “NO” in Step S29, then the write data and the new check information in the physical domain are deleted (Step S30). More specifically, this processing is a processing in which the pointers of the physical domain retrieval entry table 72 are rewritten to disable retrieval of the cache page on the basis of the address, and the cache page is made the cache page of the work domain 33. That is to say, this processing is a processing for releasing data from a state in which the data is associated with the physical address. On the other hand, if it is judged that a write error occurs, that is, a judgment is “YES” in Step S29, then the processing is completed with the write data and the new check information being left in the physical domain 32.

A processing for writing a cache page of the physical domain remaining after completion of the disk write processing to the respective disks will now be described with reference to a flowchart of FIG. 7. Each of the directors 51 and 52 periodically monitors the cache pages of the physical domain 32. The monitor processing and the write command processing (Step S31) are asynchronously executed. The monitor processing is to retrieve the cache pages of the physical domain 32 (Step S32).

If it is judged that the cache page of the physical domain 32 is present, that is, a judgment is “YES” in Step S32, then data is transferred from the cache page to the respective disks (Step S33). That is to say, the write data remaining in the physical domain and the new check information are actually written to the respective disks.

Thereafter, it is judged on the basis of the results of the write processing to the respective disks whether or not an error occurs (Step S34). If it is judged that no error occurs, that is, a judgment is “NO” in Step S34, then the cache page is deleted (Step S35). More specifically, this processing, similarly to the foregoing, is a processing in which the pointers of the physical domain retrieval entry table 72 are rewritten to disable retrieval of the cache page on the basis of the address, and the cache page is made into a cache page of the work domain 33. On the other hand, if it is judged that an error occurs, that is, a judgment is “YES” in Step S34, then the processing is completed with the cache page being left in the physical domain.

The above-mentioned processing for monitoring the physical domain shown in FIG. 7 is executed all the time, and the processing for writing the data left in the physical domain, i.e., the data which is associated with the physical address is preferentially executed.

As described above, in the write processing to the disks, the write data to be written and the check information which is to be updated so as to follow the write data are, before executing the write processing to the disks, managed in the form of the data on the cache page of the physical domain retrievable with the physical address on the cache memory. Accordingly, even when a director goes down during execution of the write processing due to occurrence of a failure, another alternate director continuously executes the preferential processing for the data which is associated with the physical address. Consequently, the write processing before occurrence of a failure can be continuously executed, and hence data coherency can be maintained. As a result, it is possible to enhance reliability of the disk array apparatus.

In addition, even in a case where a failure occurs in a director that is not duplicated, or even in a case where a director is duplicated but a failure occurs that stops the operation of the whole disk array apparatus, e.g., a power supply failure occurring during execution of the write processing, a cache memory is composed of a non-volatile memory, whereby the data is preferentially executed which is associated with the physical address and which is left in the non-volatile memory even after the system is restored. Hence, the write processing before occurrence of a failure can be continuously executed, and thus data coherency can be maintained.

Moreover, even when an error is generated due to a disk failure, data which cannot be written is managed in the form of data on the cache page of the physical domain, whereby even if a faulty disk is not immediately disabled, the data processing can be continuously executed. For this reason, in a case where a disk failure is a minor failure such as a momentary failure, or a local failure, the disk can be continuously used. Thus, the frequency of disk exchange is reduced, and as a result, it is possible to reduce an operation cost.

Since the present invention is preferably constituted and functions as described above, even when a failure occurs in the disk or the control unit during execution of the processing for writing data to the respective disks, the data as an object of the processing to the disks remains on the cache page of the physical domain. Then, when accessing the address in the writing processing, the processing for the data on the cache page of the physical domain takes precedence over the processing for the data on the disk. Consequently, excellent effects, which cannot be obtained in the prior art, can be offered such that the processing can be continuously executed while maintaining data coherency and it is possible to enhance reliability of the reading and writing processing.

In addition, even when a power supply failure occurs during execution of the write processing so that the whole disk array apparatus goes down, since the cache memory is preferably of a non-volatile type, the data during execution of the write processing remains on the cache page of the physical domain. After the disk array apparatus is restored, the director can continuously execute the processing while maintaining data coherency.

What is claimed is:

1. A disk array apparatus comprising:
a cache memory for temporarily storing data to be read from or written to disks; and
a control unit which associates data associated with logical addresses with physical addresses, writes the data associated with physical address in the cache memory and processes preferentially for writing the data associated with the physical addresses in the cache memory to the disks.

2. The disk array apparatus as claimed in claim 1,
wherein said control unit releases the data associated with the physical addresses in the cache memory from a state in which the data is associated with the physical addresses after confirming that the writing is completed.

3. The disk array apparatus as claimed in claim 1,
wherein said control unit comprises a plurality of control units which are-physically independent of one another and wherein if a failure occurs in one control unit, another control unit takes over the preferential processing for the data associated with a physical address in the cache memory.

4. The disk array apparatus as claimed in claim 1,
wherein said cache memory is a nonvolatile memory.

5. The disk array apparatus as claimed in claim 2,
wherein said cache memory is a nonvolatile memory.

6. The disk array apparatus as claimed in claim 3,
wherein said cache memory is a nonvolatile memory.

7. A data writing method in a disk array apparatus for reading and writing data from and to a plurality of disks in accordance with a command issued from an upper-level host computer, the method comprising the steps of:
before executing a processing for writing data to the plurality of disks, associating data associated with logical addresses with physical addresses to be temporarily stored in a cache memory;
associating data associated with logical addresses with physical addresses;
writing the data associated with physical address in the cache memory; and
processing preferentially for writing the data associated with the physical addresses in the cache memory to the disks.

8. The data writing method as claimed in claim 7, further comprising the step of:
releasing the data associated with the physical addresses in the cache memory from a state in which the data is associated with the physical addresses after confirming that the writing is completed.

9. The data writing method as claimed in claim 7,
wherein said control unit comprises a plurality of control units which are physically independent of one another and wherein, if a failure occurs in one control unit, another control unit takes over the preference processing for the data associated with a physical address in the cache memory.

10. The data writing method as claimed in claim 8,
wherein said control unit comprises a plurality of control units which are physically independent of one another and wherein, if a failure occurs in one control unit, another control unit takes over the preference processing for the data associated with a physical address in the cache memory.
